(19) United States
(12) Patent Application Publication
(10) Pub. No.: US 2024/0161466 A1
(43) Pub. Date: May 16, 2024

(54) DATA CREATION APPARATUS, DATA CREATION METHOD, PROGRAM, AND RECORDING MEDIUM

(71) Applicant: FUJIFILM Corporation, Tokyo (JP)

(72) Inventors: Toshiki KOBAYASHI, Saitama (JP); Yuya NISHIO, Saitama (JP); Kenkichi HAYASHI, Saitama (JP); Shoki KASAHARA, Saitama (JP)

(73) Assignee: FUJIFILM Corporation, Tokyo (JP)

(21) Appl. No.: 18/418,139

(22) Filed: Jan. 19, 2024

Related U.S. Application Data
(63) Continuation of application No. PCT/JP2022/027338, filed on Jul. 12, 2022.

(30) Foreign Application Priority Data
Jul. 30, 2021 (JP) 2021-125832

(51) Int. Cl. G06V 10/774; G06V 10/771; G06V 10/778

(52) U.S. Cl. CPC G06V 10/774; G06V 10/771; G06V 10/7788

(57) ABSTRACT

In a data creation apparatus, a data creation method, a program, and a recording medium of the present invention, a first condition for selecting first selection image data based on the accessory information from the plurality of pieces of image data is set, the first selection image data in which the accessory information conforming to the first condition is recorded is selected from the plurality of pieces of image data, a second condition for selecting second selection image data based on the accessory information from non-selection image data that does not conform to the first condition among the plurality of pieces of image data is suggested, and the training data is created based on the first selection image data in a case where a user has not employed the second condition, and the training data is created based on the first selection image data and on the second selection image data in a case where the user has employed the second condition. Accordingly, the training data can be created by selecting various and diverse pieces of image data intended by the user from an enormous amount of image data in accordance with an aim and a purpose of the machine learning.

### CROSS-REFERENCE TO RELATED APPLICATIONS

This application is a Continuation of PCT International Application No. PCT/JP2022/027338 filed on Jul. 12, 2022, which claims priority under 35 U.S.C. § 119(a) to Japanese Patent Application No. 2021-125832 filed on Jul. 30, 2021. The above applications are hereby expressly incorporated by reference, in their entirety, into the present application.

### BACKGROUND OF THE INVENTION

### 1. Field of the Invention

One embodiment of the present invention relates to a data creation apparatus, a data creation method, a program, and a recording medium for creating training data for causing artificial intelligence to perform machine learning.

### 2. Description of the Related Art

In the case of causing artificial intelligence to perform machine learning using training data, annotation work for selecting appropriate training data in accordance with an aim and a purpose of the machine learning (an aim and a purpose of the artificial intelligence) is important. However, selecting image data for creating appropriate training data from an enormous amount of image data in accordance with the aim and the purpose of the machine learning and creating the training data based on the selected image data require significant effort and processing time. Consequently, a cost for creating the training data is increased.

On the other hand, in recent years, it has been suggested to automatically select the image data from the enormous amount of the image data and create the training data based on the selected image (for example, refer to JP2011-150381A and JP2019-114243A).

### SUMMARY OF THE INVENTION

However, in JP2011-150381A and JP2019-114243A, since the image data for creating the training data is automatically selected from the enormous amount of the image data, a problem arises in that image data intended by a user may not be selected.

On the other hand, the image data intended by the user can be selected from the enormous amount of the image data by causing the user to set a selection condition. However, in this case, only the image data conforming to the selection condition set by the user is selected, and image data conforming to a selection condition not set by the user is not selected. Thus, a problem arises in that it is difficult to select a wide range of various and diverse pieces of image data from the enormous amount of the image data in accordance with the aim and the purpose of the machine learning.

Accordingly, an aim according to one embodiment of the present invention is to provide a data creation apparatus, a data creation method, a program, and a recording medium that can create training data by selecting various and diverse pieces of image data intended by a user from an enormous amount of image data in accordance with an aim and a purpose of machine learning.

In order to achieve the above aim, the present invention provides a data creation apparatus that creates training data for performing machine learning from a plurality of pieces of image data in which accessory information is recorded, the data creation apparatus comprising a processor, in which the processor is configured to execute setting processing of setting a first condition for selecting first selection image data based on the accessory information from the plurality of pieces of image data, selection processing of selecting the first selection image data in which the accessory information conforming to the first condition is recorded from the plurality of pieces of image data, suggestion processing of suggesting a second condition for selecting second selection image data based on the accessory information from non-selection image data that does not conform to the first condition among the plurality of pieces of image data, and creation processing of creating the training data based on the first selection image data in a case where a user has not employed the second condition and creating the training data based on the first selection image data and on the second selection image data in a case where the user has employed the second condition.

Here, it is preferable that the processor is configured to, in a case where the user has employed the second condition, execute second selection processing of selecting the second selection image data in which the accessory information conforming to the second condition is recorded from the non-selection image data.

In addition, it is preferable that the processor is configured to execute the machine learning based on an employment result of whether or not the user has employed the second condition, and in the suggestion processing, the second condition is suggested based on the machine learning of the employment result.

In addition, it is preferable that the processor is configured to execute notification processing of providing notification of information related to the second condition.

In addition, it is preferable that the first condition and the second condition include an item related to the accessory information and content related to the item.

In addition, it is preferable that the first condition and the second condition have the same item and different content.

In addition, it is preferable that the item is availability information related to use of image data as the training data.

In addition, it is preferable that the availability information includes at least one of user information related to use of the image data, restriction information related to restriction of an aim of use of the image data, or copyright holder information of the image data.

In addition, it is preferable that the content of the first condition is content of selecting image data based on the availability information, and the content of the second condition is content of selecting image data in which the availability information is not recorded or image data in which the availability information indicating that there is no restriction on use of the image data is recorded.

In addition, it is preferable that the item is an item related to a type of a subject captured in an image based on image data.

In addition, it is preferable that the first condition is a condition related to a subject captured in an image based on image data, and the suggestion processing is processing of suggesting the second condition based on a feature of the subject of the first condition.

In addition, it is preferable that the suggestion processing is processing of suggesting the second condition of a higher-level concept obtained by making the first condition more abstract.

In addition, the present invention provides a data creation method of creating training data for performing machine learning from a plurality of pieces of image data in which accessory information is recorded, the data creation method comprising a setting step of setting a first condition for selecting first selection image data based on the accessory information from the plurality of pieces of image data, a selection step of selecting the first selection image data in which the accessory information conforming to the first condition is recorded from the plurality of pieces of image data, a suggestion step of suggesting a second condition for selecting second selection image data based on the accessory information from non-selection image data that does not conform to the first condition among the plurality of pieces of image data, and a creation step of creating the training data based on the first selection image data in a case where a user has not employed the second condition and creating the training data based on the first selection image data and on the second selection image data in a case where the user has employed the second condition.

In addition, the present invention provides a program causing a computer to execute each processing of any of the data creation apparatuses.

In addition, the present invention provides a computer readable recording medium on which a program causing a computer to execute each processing of any of the data creation apparatuses.

According to the present invention, a data creation apparatus, a data creation method, a program, and a recording medium that can create training data by selecting various and diverse pieces of image data intended by a user from an enormous amount of image data in accordance with an aim and a purpose of machine learning can be provided.

### BRIEF DESCRIPTION OF THE DRAWINGS

FIG. 1 is a block diagram representing a configuration of a data processing system according to one embodiment of the present invention.

FIG. 2 is a block diagram of one embodiment representing an internal configuration of the data creation apparatus illustrated in FIG. 1.

FIG. 3 is a conceptual diagram of one embodiment representing an internal configuration of image data.

FIG. 4 is a conceptual diagram of one embodiment representing selection processing of selecting first selection image data in which accessory information conforming to a first condition is recorded from a plurality of pieces of image data.

FIG. 5 is a conceptual diagram of one embodiment representing second selection processing of selecting second selection image data in which the accessory information conforming to a second condition is recorded from non-selection image data.

FIG. 6 is a conceptual diagram of one embodiment representing a configuration of the accessory information.

FIG. 7 is a conceptual diagram of one embodiment representing a configuration of imaging condition information.

FIG. 8 is a conceptual diagram of one embodiment representing a configuration of subject information.

FIG. 9 is a conceptual diagram of one embodiment representing a configuration of image quality information.

FIG. 10 is a conceptual diagram of one embodiment representing a configuration of availability information.

FIG. 11 is a conceptual diagram of one embodiment representing a configuration of history information.

FIG. 12 is a flowchart of one embodiment representing an operation of the data processing system illustrated in FIG. 1.

FIG. 13 is a conceptual diagram of one embodiment representing an input screen for causing a user to input a selection condition.

FIG. 14 is a conceptual diagram of one embodiment representing a presentation screen for suggesting the second condition.

### DESCRIPTION OF THE PREFERRED EMBODIMENTS

Hereinafter, a data creation apparatus, a data creation method, a program, and a recording medium according to one embodiment of the present invention will be described in detail based on a suitable embodiment illustrated in the accompanying drawings. It should be noted that the embodiment described below is merely an example for facilitating understanding of the present invention and does not limit the present invention thereto. That is, changes or improvements may be made from the embodiment described below without departing from the gist of the present invention. In addition, the present invention includes equivalents thereof.

In addition, in the present specification, a concept of an “apparatus” includes not only a single apparatus that exhibits a specific function but also a plurality of apparatuses and the like that are distributed independently of each other and that cooperate to exhibit a specific function. In addition, in the present specification, a “person” means an agent that performs a specific action, and its concept includes not only an individual, a group, a corporation, and an organization but also a computer and a device constituting artificial intelligence.

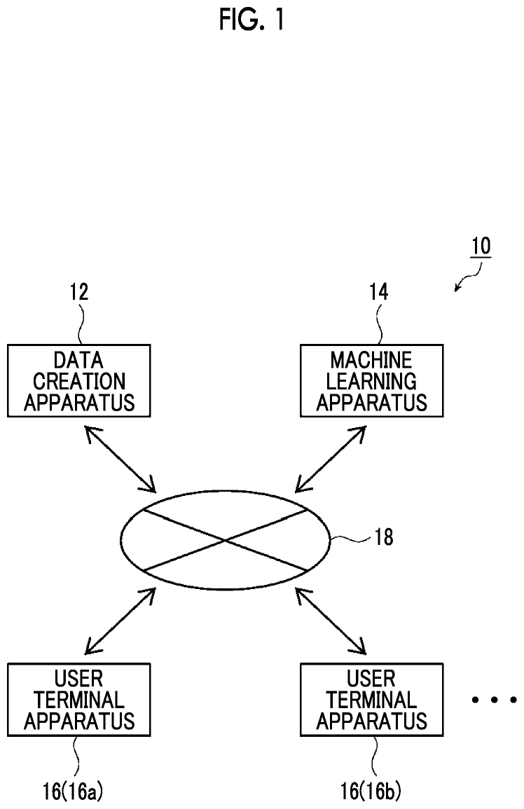

FIG. 1 is a block diagram representing a configuration of a data processing system according to one embodiment of the present invention. A data processing system 10 illustrated in FIG. 1 comprises a data creation apparatus 12, a machine learning apparatus 14, and a plurality of user terminal apparatuses 16 (16a, 16b, . . . ).

The data creation apparatus 12, the machine learning apparatus 14, and each of the plurality of user terminal apparatuses 16 are bidirectionally connected through a network 18 such as the Internet or a mobile data communication line and can transmit and receive various types of data to and from each other.

The data creation apparatus 12 and the machine learning apparatus 14 may be configured as individual apparatuses as in the present embodiment or may be configured to be integrated into one apparatus. In addition, while the data processing system 10 may comprise the plurality of user terminal apparatuses 16 as in the present embodiment, it is not essential to comprise the plurality of user terminal apparatuses 16, and at least one user terminal apparatus 16 may be comprised.

The data creation apparatus 12 performs annotation work of creating training data for causing artificial intelligence to perform machine learning from a plurality of pieces of image data in which accessory information is recorded (assigned). For example, the data creation apparatus 12 is composed of a computer such as a personal computer (PC), a workstation, or a server and comprises an input device, a display, a memory (storage device), a communication device, a control device, and the like.

The artificial intelligence implements intellectual functions such as reasoning, prediction, and determination using hardware resources and software resources. The artificial intelligence is implemented using any algorithm such as, for example, an expert system, case-based reasoning (CBR), a Bayesian network, or a subsumption architecture. The machine learning is an analysis technology or the like related to a technology and artificial intelligence for learning regularity and a determination reference from data and predicting and determining an unknown thing based on the regularity and on the determination reference.

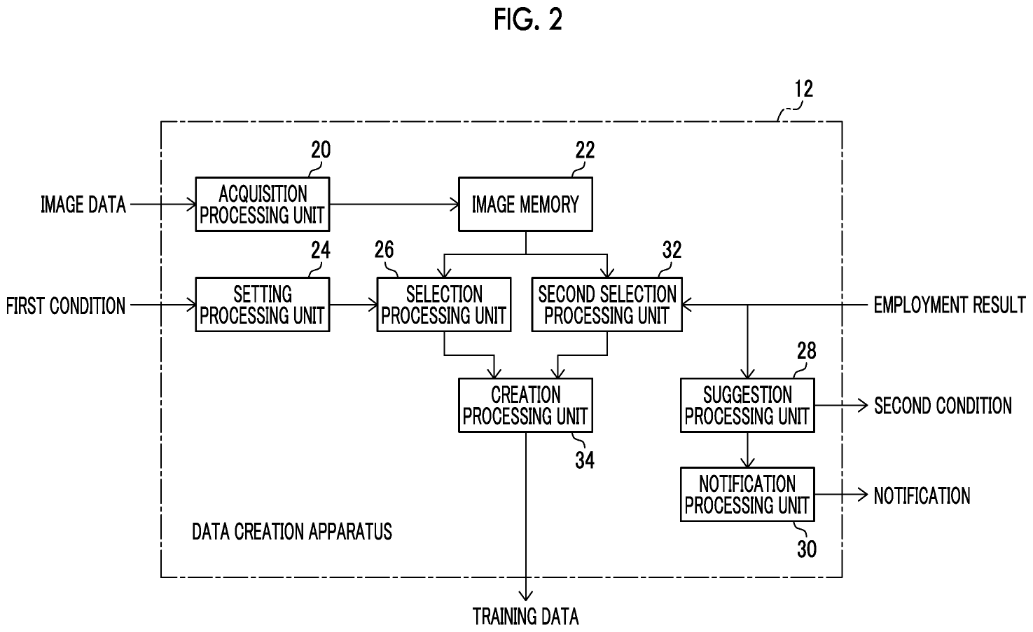

FIG. 2 is a block diagram of one embodiment representing an internal configuration of the data creation apparatus illustrated in FIG. 1. As illustrated in FIG. 2, the data creation apparatus 12 comprises an acquisition processing unit 20, an image memory 22, a setting processing unit 24, a selection processing unit 26, a suggestion processing unit 28, a notification processing unit 30, a second selection processing unit 32, and a creation processing unit 34.

The image data is input into the acquisition processing unit 20, and the image memory 22 is connected to the acquisition processing unit 20. A first condition is input into the setting processing unit 24, and the selection processing unit 26 is connected to the setting processing unit 24. Each of the selection processing unit 26 and the second selection processing unit 32 is connected to the image memory 22, and the creation processing unit 34 is connected to the selection processing unit 26 and to the second selection processing unit 32. The training data is output from the creation processing unit 34. An employment result of a second condition is input into the second selection processing unit 32 and into the suggestion processing unit 28, and the second condition is output from the suggestion processing unit 28. The notification processing unit 30 is connected to the suggestion processing unit 28, and notification is output from the notification processing unit 30.

The acquisition processing unit 20 executes acquisition processing of acquiring the plurality of pieces of image data from at least one of a plurality of supply sources of the image data.

The supply source of the image data is not particularly limited. For example, the acquisition processing unit 20 can acquire the image data selected (designated) by a user in the user terminal apparatus 16, the image data posted on a website where images can be published or shared, such as a social networking service (SNS), and the image data stored in an online storage, an image server, or the like.

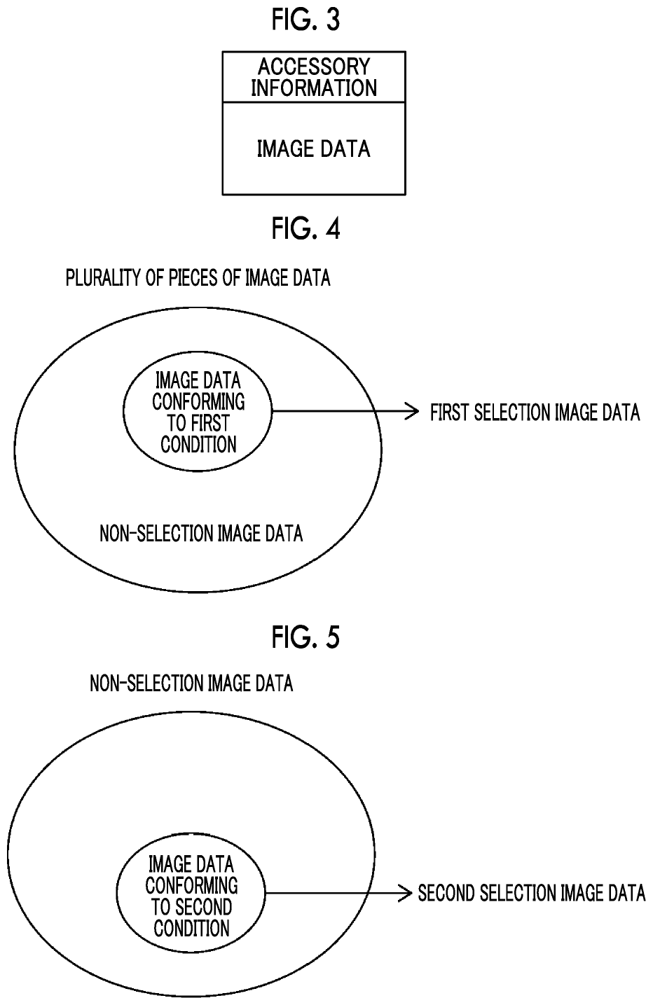

As illustrated in FIG. 3, the accessory information is recorded in each of the plurality of pieces of image data. The accessory information includes various types of tag information (label information). For example, the accessory information may be recorded as header information of the image data. Alternatively, the accessory information may be prepared as accessory information data separate from the image data, and the image data and the accessory information data corresponding to the image data may be recorded in association with each other. The accessory information will be described in detail later.

The image memory 22 stores the plurality of pieces of image data.

The image memory 22 may acquire the plurality of pieces of image data acquired by the acquisition processing unit 20, or the plurality of pieces of image data may be stored in advance in the image memory 22.

The image memory 22 is not particularly limited. For example, the image memory 22 may be various recording media such as a hard disk drive (HDD), a solid state drive (SSD), a random access memory (RAM), a secure digital card (SD card), and a universal serial bus memory (USB memory). Alternatively, an online storage, an image server, or the like may be used.

The setting processing unit 24 executes setting processing of setting the first condition related to the accessory information.

The first condition is a selection condition for selecting (searching for) first selection image data from the plurality of pieces of image data stored in the image memory 22 based on the accessory information. The first condition will be described in detail later.

A method of setting the first condition is not particularly limited. For example, the setting processing unit 24 can set the selection condition input by the user as the first condition. For example, in the case of creating the artificial intelligence for the purpose (aim of use) of estimating whether or not a subject captured in an image is “apple”, the user inputs the selection condition of “apple” as the first condition. In this case, the setting processing unit 24 sets the selection condition of “apple” input by the user as the first condition.

The first condition may be one selection condition or may be an AND condition or an OR condition of two or more selection conditions.

Alternatively, a table in which the purpose and the first condition corresponding to the purpose are stored in association with each other for each aim and purpose of the machine learning can be prepared, and the setting processing unit 24 can set the first condition associated with the aim and the purpose of the machine learning input by the user using the table. In this case, the user may manually input the aim and the purpose of the machine learning as the selection condition or can select a desired purpose from a list of the aims and the purposes of the machine learning stored in the table using a pull-down menu or the like.

As illustrated in FIG. 4, the selection processing unit 26 executes selection processing of selecting the image data (first selection image data) in which the accessory information conforming to the first condition set by the setting processing unit 24 is recorded from the plurality of pieces of image data.

A method of selecting the first selection image data is not particularly limited. For example, the selection processing unit 26 can select the first selection image data in which the accessory information conforming to the first condition is recorded from the plurality of pieces of image data by comparing the first condition with the accessory information recorded in each of the plurality of pieces of image data. For example, in a case where the first condition is “apple”, the selection processing unit 26 selects the first selection image data in which the accessory information corresponding to “apple” is recorded.

The accessory information conforming to the first condition may include not only the accessory information completely matching the first condition but also the accessory information including the first condition. For example, in a case where the first condition is “apple”, not only the accessory information corresponding to “apple” but also the accessory information corresponding to “red apple” and the like may be included.

The suggestion processing unit 28 executes suggestion processing of suggesting the second condition related to the accessory information from non-selection image data that does not conform to the first condition, that is, non-selection image data that is not selected as the first selection image data, among the plurality of pieces of image data.

The non-selection image data is the image data other than the image data selected as the first selection image data among the plurality of pieces of image data and includes one or two or more pieces of image data.

The second condition is the selection condition different from the first condition and is the selection condition for selecting second selection image data different from the first selection image data from the non-selection image data based on the accessory information. In addition, the second condition is the selection condition that is automatically set by the suggestion processing unit 28 to be suggested to the user independently of an instruction from the user. The second condition will be described in detail later.

A method of suggesting the second condition is not particularly limited. For example, a table in which the first condition and the second condition corresponding to the first condition are stored in association with each other for each first condition can be prepared, and the suggestion processing unit 28 can suggest the second condition associated with the first condition using the table. For example, in a case where the first condition is “apple”, adding the image data of peach that is similar in appearance to an apple can improve accuracy of an estimation result of the artificial intelligence. Thus, in a case where “apple” and “peach” are associated with each other in the table, the setting processing unit 24 suggests “peach” as the second condition.

A suggestion timing of the second condition is not particularly limited and may be, for example, between the selection processing of selecting the first selection image data and the suggestion processing of suggesting the second condition or between the selection processing and creation processing of creating the training data, described later.

Alternatively, the suggestion processing unit 28 may suggest the second condition estimated from the first condition using the artificial intelligence for performing the suggestion processing.

The second condition may be one selection condition or may be an AND condition or an OR condition of two or more selection conditions, in the same manner as the first condition.

The notification processing unit 30 executes notification processing of providing notification of information related to the second condition suggested by the suggestion processing unit 28.

The information related to the second condition is not particularly limited and can be illustrated by the reason for suggestion of the second condition, the number of times or an employment ratio at which the same second condition was employed in the past, accuracy of suggestion content (estimation result) of the second condition provided by the artificial intelligence, and the like.

For example, in a case where the first condition is “apple” and the suggestion processing unit 28 has suggested “peach” as the second condition, the notification processing unit 30 notifies the user of the reason for suggestion such as “adding the image data of peach that is similar in appearance to an apple can improve the accuracy of the estimation result of the artificial intelligence”. Accordingly, since the user can know the reason for suggestion of the second condition by being notified of the reason for suggestion, the user can easily determine whether or not to employ the second condition based on the reason for suggestion.

A method of notification is not particularly limited. For example, in the user terminal apparatus 16, a text message may be displayed, the text message may be read as a speech using speech synthesis, or both may be performed.

In a case where the user has employed the second condition in accordance with suggestion of the second condition by the suggestion processing unit 28, the second selection processing unit 32 executes second selection processing of selecting the image data (second selection image data) in which the accessory information conforming to the second condition is recorded from the non-selection image data as illustrated in FIG. 5. In other words, in a case where the user has not employed the second condition, the second selection processing unit 32 does not execute the second selection processing and does not select the second selection image data.

The second selection processing unit 32 can select the second selection image data from the non-selection image data in the same manner as a case where the selection processing unit 26 selects the first selection image data from the plurality of pieces of image data.

In a case where the user has not employed the second condition in accordance with suggestion of the second condition by the suggestion processing unit 28, the second selection image data is not selected. Thus, the creation processing unit 34 executes the creation processing of creating the training data based on the first selection image data. Meanwhile, in a case where the user has employed the second condition, the second selection image data is selected. Thus, the creation processing unit 34 executes the creation processing of creating the training data based on the first selection image data and on the second selection image data.

The creation processing unit 34 may use the first selection image data or the second selection image data itself as the training data or may create the training data by performing various types of image processing with respect to at least one of the first selection image data or the second selection image data.

In the present embodiment, the acquisition processing unit 20, the setting processing unit 24, the selection processing unit 26, the suggestion processing unit 28, the notification processing unit 30, the second selection processing unit 32, and the creation processing unit 34 are composed of a processor and a program executed by the processor.

The machine learning apparatus 14 creates a machine-trained inference model by causing the artificial intelligence to perform the machine learning using a plurality of pieces of the training data created by the data creation apparatus 12.

The inference model constructed by the machine learning is any mathematical model. For example, a neural network, a convolutional neural network, a recurrent neural network, attention, a transformer, a generative adversarial network, a deep learning neural network, a Boltzmann machine, matrix factorization, a factorization machine, an M-way factorization machine, a field-aware factorization machine, a field-aware neural factorization machine, a support vector machine, a Bayesian network, a decision tree, or a random forest can be used.

The user terminal apparatus 16 causes the data creation apparatus 12, the machine learning apparatus 14, and the like to perform various types of processing in accordance with an instruction input from the user. In the present embodiment, in accordance with the instruction input from the user, the user terminal apparatus 16 causes the data creation apparatus 12 to create the training data corresponding to the aim and the purpose of the machine learning and causes the machine learning apparatus 14 to create a trained estimation model by causing the artificial intelligence to perform the machine learning using the training data and estimate the aim and the purpose of the machine learning using the trained estimation model.

The user terminal apparatus 16 is composed of a computer including, for example, a desktop PC, a laptop PC, a tablet PC, or a smartphone and comprises an input device, a display, a memory (storage device), a communication device, a control device, and the like.

Next, the accessory information will be described.

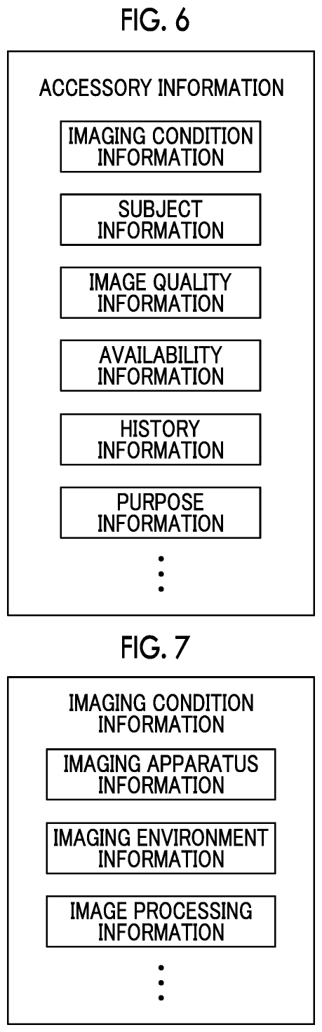

The accessory information includes various types of tag information (label information) used for selecting the first selection image data conforming to the first condition from the plurality of pieces of image data and for selecting the second selection image data conforming to the second condition from the non-selection image data. The accessory information is not particularly limited and, as illustrated in FIG. 6, includes at least one of imaging condition information, subject information, image quality information, availability information, history information, purpose information, or the like as the tag information.

The imaging condition information is information related to an imaging condition of the image based on the image data and includes at least one of imaging apparatus information, imaging environment information, image processing information, or the like as the tag information in the exchangeable image file format (Exit) as illustrated in FIG. 7.

The imaging apparatus information is information related to an imaging apparatus (camera) and includes information such as a manufacturer of the imaging apparatus, a model name of the imaging apparatus, and a type of light source of the imaging apparatus.

The imaging environment information is information related to an imaging environment of the image and includes information such as an imaging date and time, a season during imaging, an imaging location, a place name of the imaging location, an exposure condition (an f number, ISO sensitivity, a shutter speed, and the like) during imaging, weather during imaging, and illuminance (amount of solar radiation) during imaging.

The image processing information is information related to image processing performed with respect to the image by the imaging apparatus and includes information such as a name of the image processing, a feature of the image processing, a model of an apparatus that can execute the image processing, and a region on which the processing is performed in the image.

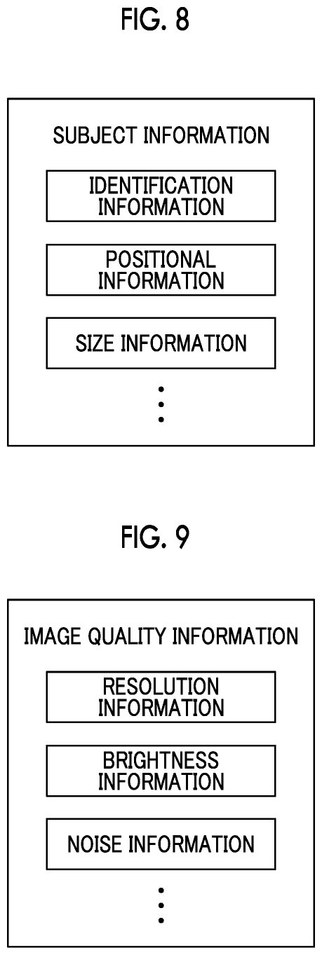

The subject information is information related to the subject captured in the image based on the image data and, as illustrated in FIG. 8, includes at least one of identification information, positional information, size information, or the like of the subject in the image.

The identification information is information related to a type (kind), a state, a feature (a color, a shape, a pattern, and the like), and the like of the subject in the image. For example, information such that the type of the subject is “apple”, the state of the subject is a ripe state, and the feature of the subject is red and round corresponds to the identification information.

The positional information is information related to a position of the subject in the image and includes, for example, information about a predetermined position of a rectangular region (for example, a coordinate position of one vertex angle in the rectangular region) in a case where the subject in the image is surrounded by a bounding box.

The size information is information related to a size of a region occupied by the subject in the image and includes, for example, information about coordinate positions of two vertex angles on a diagonal line of the rectangular region.

The image quality information is information related to image quality of the subject captured in the image based on the image data and, as illustrated in FIG. 9, includes at least one of resolution information, brightness information, noise information, or the like of the subject.

The resolution information is information related to resolution of the subject in the image and includes, for example, information about blurriness and shake levels of the subject and a resolution level of the subject. The blurriness and shake levels of the subject may be a representation in number of pixels, a stepwise evaluation such as a rank or a grade of 1 to 5, an evaluation using a score, or a result of sensory evaluation that is a stepwise evaluation using a scale based on sensitivity of a person.

The brightness information is information related to brightness (brightness value) of the subject in the image and includes, for example, information about a brightness value of each color of red, green, and blue (RGB) in each pixel within the rectangular region surrounding the subject.

The noise information is information related to noise of the subject in the image and includes, for example, information about a signal-to-noise ratio (S/N value) within the rectangular region surrounding the subject.

The subject information and the image quality information are assigned for each subject in the image. That is, in a case where a plurality of subjects are captured in the image, the subject information and the image quality information corresponding to the subject are assigned for each subject.

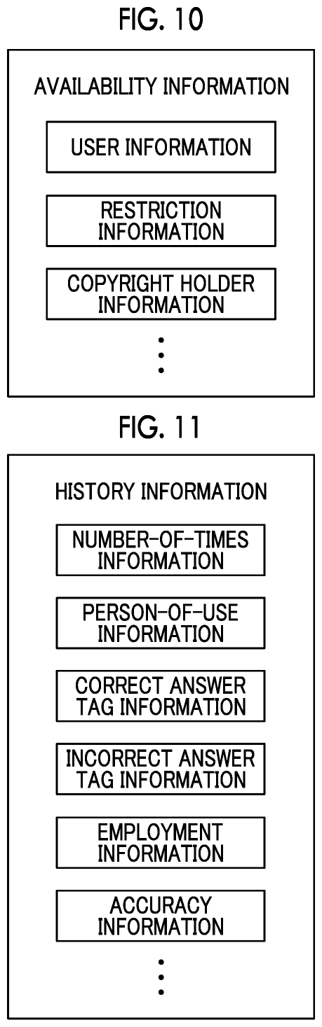

The availability information is information related to use of the image data as the training data and, as illustrated in FIG. 10, includes at least one of user information, restriction information, copyright holder information, or the like.

The user information is information related to a user of the image data and includes, for example, information for restricting use of the image data for a specific user, such as “usable by only Person A” or “usable by only Company B”, and information indicating that there is no user restriction on the image, such as “usable by any person”. The user information includes at last one of information about the user who is allowed to use the image data or information about the user who is not allowed to use the image data.

The restriction information is information related to restriction of the aim of use of the image data and includes, for example, information for restricting the aim of use of the image data, such as “commercial use is restricted”, and information indicating that there is no restriction on the aim of use of the image data, such as “usable for any aim”.

The copyright holder information is information related to a copyright holder of the image data and includes, for example, information for specifying the copyright holder of the image data, such as “copyright holder is Company B”, and information indicating that there is no copyright holder of the image data, such as “no copyright holder”. The copyright holder information is not limited to the copyright holder of the image data and may be information related to a creator of the image data, such as identification information (ID; identification information) and a nickname.

The availability information, that is, each of the user information, the restriction information, and the copyright holder information, may further include period information related to a usable period of the image data. That is, each of the user information, the restriction information, and the copyright holder information may include information related to restriction of a time of use of the image data, for example, information such as expiration by which the image data can be used or a period in which the image data can be used without payment or on payment.

It is desirable to ensure security of the availability information using a method such as encryption or hashing to avoid unauthorized alteration.

The history information is information related to a learning history in the machine learning in the past using the image data and, as illustrated in FIG. 11, includes at least one of number-of-times information, person-of-use information, correct answer tag information, incorrect answer tag information, employment information, accuracy information, or the like.

The number-of-times information is information related to the number of times the image data was used for creating the training data in the machine learning in the past.

The person-of-use information is information related to a person of use (user) who used the image data for creating the training data in the machine learning in the past.

The correct answer tag information and the incorrect answer tag information are information related to whether the training data created based on the image data was used as correct answer data or used as incorrect answer data in the machine learning in the past.

The employment information is information related to whether or not the training data created based on the image data was employed as the incorrect answer data in the machine learning in the past.

The accuracy information is information related to the accuracy of the estimation result of the artificial intelligence of which the machine learning was performed using the training data created based on the image data in the machine learning in the past.

The purpose information is information related to a learning purpose of the machine learning (learning purpose of the artificial intelligence). Specifically, the purpose information is information representing the purpose of the machine learning of the artificial intelligence for which the training data created based on the image data can be used. Accordingly, the purpose of the machine learning of the artificial intelligence for which the image data can be used for creating the training data can be specified by referring to the purpose information.

In the accessory information, the imaging condition information, the subject information, and the image quality information can be assigned to the image data by, for example, automatically generating the tag information via the imaging apparatus that has captured the image. In addition, the entire accessory information, that is, the imaging condition information, the subject information, the image quality information, the availability information, the history information, the purpose information, and the like, may be assigned to the image data by causing the user to manually input the tag information in the user terminal apparatus 16. Alternatively, the tag information may be automatically estimated from the image data using the artificial intelligence for assigning the tag information, and the estimated tag information may be assigned to the image data.

Next, the first condition and the second condition will be described.

As the first condition and the second condition, any selection condition can be used in accordance with the aim and the purpose of the machine learning. In the case of creating the artificial intelligence for the purpose of estimating whether or not the subject in the image is “apple”, “apple”, for example, can be set as the first condition, and “peach”, for example, different from the first condition can be suggested as the second condition.

In addition, the first condition and the second condition may include an item related to the accessory information and content related to the item. In other words, the first condition and the second condition may be an AND condition of two selection conditions of the item and the content.

The item represents a category of a higher-level concept including a plurality of pieces of the tag information of different types, and the content represents an individual element of a lower-level concept belonging to the category. For example, in a case where the item is “fruit”, the content is “apple”, “peach”, “mandarin orange”, and the like. In a case where the item is “automobile”, the content is “passenger car”, “bus”, “truck”, and the like. In a case where the item is “seaweed”, the content is “kombu”, “wakame”, “mozuku”, and the like.

As described above, the first condition and the second condition are defined by the item and the content. For example, conditions having the same item and different content can be used as the first condition and the second condition.

In addition, the item can include an item related to the type of the subject as described above. In addition, the item can include an item related to the feature of the subject and to the position, the size, and the like of the subject in the image. Furthermore, the item can include at least one of an item related to the availability information of the image data, an item related to the imaging condition, an item related to the image quality, or an item related to the history information of the image data.

To describe with several specific examples, in a case where “user information” and “usable by only Company B” are set as the item and the content of the first condition, the same “user information” as the first condition and “usable by any person” different from the first condition can be suggested as the item and the content of the second condition. In the same manner, in a case where “fruit” and “apple” as the item and the content of the first condition, “fruit” and “peach” can be suggested as the item and the content of the second condition. In a case where an AND condition of “fruit” and “apple” and “weather” and “sunny” is set as the item and the content of the first condition, an AND condition of “fruit” and “peach” and “weather” and “cloudy” can be suggested as the item and the content of the second condition. In a case where “tree” and “wood” are set as the item and the content of the first condition, “tree” and “forest” can be suggested as the item and the content of the second condition. In a case where “car” and “passenger car” are set as the item and the content of the first condition, “car” and “bus” can be suggested as the item and the content of the second condition.

Accordingly, by suggesting the second condition, selection of the second selection image data to be used for creating the training data can be promoted, and the number of pieces of the training data can be increased. Consequently, the accuracy of the estimation result of the artificial intelligence can be improved.

In the above examples, examples of “fruit”, “tree”, “car”, and the like suggest the selection condition having high similarity to the first condition as the second condition. Accordingly, by suggesting the second condition having high similarity to the first condition, for example, the training data to be used as the correct answer data is created based on the first selection image data, the training data to be used as the incorrect answer data is created based on the second selection image data, and the artificial intelligence is caused to perform the machine learning using these pieces of the training data. Consequently, similar objects can be correctly distinguished, and the accuracy of the estimation result of the artificial intelligence can be improved.

As the first condition and the second condition, selection conditions having different items and the same content may be used, or selection conditions having both of the item and the content different from each other may be used.

In addition, the item may be the availability information as in the above example of “user information”. In addition, in a case where the content of the first condition is content of selecting the image data based on the availability information, the content of the second condition may be content of selecting the image data in which the availability information is not recorded or the image data in which the availability information indicating that there is no restriction on use of the image data is recorded.

For example, in a case where a condition having content of “usable by only Company B” with respect to the item of “user information” is set as the first condition, a condition having content of “usable by any person” with respect to the item of “user information” can be suggested as the second condition. In the same manner, in a case where a condition having content of “commercial use is restricted” with respect to the item of “restriction information” is set as the first condition, a condition having content of “usable for any aim” with respect to the item of “restriction information” can be suggested as the second condition. In addition, in a case where a condition having content of “copyright holder is Company B” with respect to the item of “copyright holder information” is set as the first condition, a condition having content of “no copyright holder” with respect to the item of “copyright holder information” can be suggested as the second condition.

Accordingly, by suggesting the second condition having the content of selecting the image data in which the availability information is not recorded or the image data in which the availability information indicating that there is no restriction on use of the image data is recorded, selection of the second selection image data not restricted by the availability information can be promoted in addition to the first selection image data, and the number of pieces of the selection image data to be used for creating the training data can be increased. Consequently, the accuracy of the estimation result of the artificial intelligence can be improved.

In addition, the item may be an item related to the type of the subject captured in the image based on the image data.

For example, in a case where a condition having content of “apple” with respect to the item of “fruit” is set as the first condition, a condition having content of “strawberry” with respect to the item of “fruit” can be suggested as the second condition. That is, the type of the subject that is the items of the first condition and the second condition is “fruit”, and the content is “apple” and “strawberry”. In this case, for example, the first selection image data is used for creating the training data of the correct answer data, and the second selection image data is used for creating the training data of the incorrect answer data.

In addition, as described above, in a case where the item is the item related to the type of the subject in the image and the content includes a characteristic of the subject, the suggestion processing unit 28 may suggest a characteristic different from the characteristic of the subject of the first condition as the content of the second condition.

For example, in a case where a condition having content of “apple of Variety B produced in Prefecture A” with respect to the item of “fruit” is set as the first condition, a condition having content of “apple of Variety D produced in Prefecture C” with respect to the item of “fruit” can be suggested as the second condition. That is, the type of the subject that is the items of the first condition and the second condition is “fruit”, the content is “apple”, and the characteristic of the subject is “place of production” and “variety”.

Accordingly, bias of data caused by the characteristic of the subject in selecting the selection image data for creating the training data can be prevented, and the number of pieces of the selection image data can be increased.

In addition, in a case where the first condition is a condition related to the subject captured in the image based on the image data, the suggestion processing unit 28 may perform the suggestion processing of suggesting the second condition based on the feature, for example, a color, a shape, and a pattern, of the subject of the first condition.

For example, in a case where the first condition is “mandarin orange”, “object having an elliptical shape of an orange color” or the like can be suggested as the second condition based on the feature of “mandarin orange”. That is, the subject of the first condition is “mandarin orange”, and the feature is “elliptical shape” and “orange color”.

In this case, the second selection image data includes the image data of “mandarin orange” in which the tag information of “mandarin orange” is not recorded and the image data of, for example, a ball of an orange color that is similar to the feature of “mandarin orange” and that is not “mandarin orange”. Accordingly, for example, the training data to be used as the correct answer data can be created based on the image data of “mandarin orange” in which the tag information of “mandarin orange” is not recorded, and the training data to be used as the incorrect answer data can be created based on the image data that is similar to the feature of “mandarin orange” and that is not “mandarin orange”. In this case, for example, a person views the image based on the image data to which the tag information of “object having an elliptical shape of an orange color” similar to “mandarin orange” is assigned and determines the image as “mandarin orange” (correct answer data) or not “mandarin orange” (incorrect answer data).

In addition, the suggestion processing unit 28 may perform the suggestion processing of suggesting the second condition of a higher-level concept obtained by making the first condition more abstract.

For example, in a case where “kombu” is set as the first condition, the suggestion processing unit 28 can suggest “seaweed” that is a higher-level concept of “kombu” as the second condition.

In this case, as the first selection image data selected using “kombu” that is the first condition, the image data in which the tag information of “kombu” is recorded is selected, and the image data in which the tag information of “wakame” or “mozuku” is recorded is not selected.

On the other hand, suggesting “seaweed” of the second condition that is the higher-level concept of “kombu” of the first condition can compensate for a difference in word, food culture, and the like. Specifically, while a person of a country where “seaweed” is eaten generally uses words such as “kombu”, “wakame”, and “mozuku” in a distinguishable manner, a person of a country where “seaweed” is not eaten generally represents words such as “kombu”, “wakame”, and “mozuku” collectively as “seaweed”. Considering this point, by setting the second condition as “seaweed”, the image data in which the tag information such as “seaweed” and “wakame” or “seaweed” and “mozuku” is recorded can be selected from the plurality of pieces of image data even in a case where the tag information of “kombu” is not recorded. Thus, more pieces of the selection image data related to “kombu” can be selected.

In addition, as another example, in a case where “basket clam”, “Manila clam”, “Asian hard clam”, or the like is set as the first condition, the suggestion processing unit 28 can suggest “clam” that is a higher-level concept of these can be suggested as the second condition. The same applies to other examples.

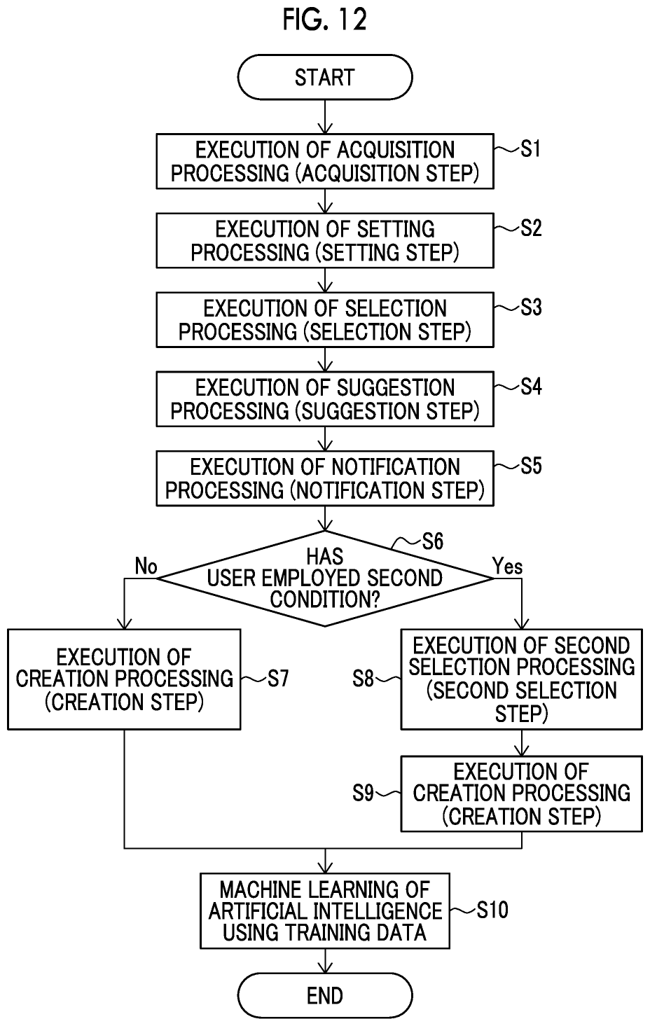

Next, an operation of the data processing system 10 will be described with reference to the flowchart illustrated in FIG. 12.

First, the acquisition processing (acquisition step) of acquiring the plurality of pieces of image data from at least one of the plurality of supply sources of the image data is executed by the acquisition processing unit 20 (step S1). The image data acquired by the acquisition processing unit 20 is stored in the image memory 22.

Meanwhile, for example, the user inputs the selection condition for selecting the image data in accordance with the aim and the purpose of the machine learning in the user terminal apparatus 16. An instruction for the selection condition input from the user is transmitted to the data creation apparatus 12 from the user terminal apparatus 16.

In response to the instruction, the setting processing (setting step) of setting the first condition related to the accessory information is executed by the setting processing unit 24 (step S2).

Next, the selection processing (selection step) of selecting the first selection image data in which the accessory information conforming to the first condition set by the setting processing unit 24 is recorded from the plurality of pieces of image data stored in the image memory 22 is executed by the selection processing unit 26 (step S3).

Next, the suggestion processing (suggestion step) of suggesting the second condition related to the accessory information is executed by the suggestion processing unit 28 (step S4). In addition, the notification processing (notification step) of providing notification of the information related to the second condition suggested by the suggestion processing unit 28 is executed by the notification processing unit 30 (step S5).

Consequently, in a case where the user has not employed the second condition in accordance with suggestion of the second condition by the suggestion processing unit 28 (No in step S6), the second selection processing (second selection step) of the second selection processing unit 32 is not executed. That is, the second selection image data is not selected.

In this case, the creation processing (creation step) of creating the training data based on the first selection image data is executed by the creation processing unit 34 (step S7).

Meanwhile, in a case where the user has employed the second condition (Yes in step S6), the second selection processing (second selection step) of selecting the second selection image data in which the accessory information conforming to the second condition is recorded from the non-selection image data is executed by the second selection processing unit 32 (step S8).

In this case, the creation processing (creation step) of creating the training data based on the first selection image data and on the second selection image data is executed by the creation processing unit 34 (step S9). This training data is transmitted to the machine learning apparatus 14 from the data creation apparatus 12.

In a case where the user has not employed the second condition, the suggestion processing unit 28 may repeatedly execute the suggestion processing (suggestion step) of suggesting the second condition in accordance with an instruction from the user.

Next, in the machine learning apparatus 14, the artificial intelligence is caused to perform the machine learning using the training data transmitted from the data creation apparatus 12, and the machine-trained inference model is created (step S10).

Next, in the user terminal apparatus 16, the user inputs the image data of an estimation target for performing estimation corresponding to the purpose of the artificial intelligence using the artificial intelligence. An instruction to input the image data of the estimation target is transmitted to the machine learning apparatus 14 from the user terminal apparatus 16.

In accordance with the instruction for the image data of the estimation target input from the user, the image data of the estimation target transmitted from the user terminal apparatus 16 is input into the artificial intelligence, and estimation corresponding to the aim and the purpose of the machine learning is performed with respect to the image data of the estimation target by the artificial intelligence using the trained estimation model in the machine learning apparatus 14. The estimation result of the artificial intelligence is transmitted to the user terminal apparatus 16 from the machine learning apparatus 14.

Next, in the user terminal apparatus 16, various types of processing are performed using the estimation result of the artificial intelligence transmitted from the machine learning apparatus 14.

As a specific example of the above series of steps, a case of creating the artificial intelligence for the purpose of estimating whether or not the subject in the image is “mandarin orange”, in other words, a case of causing the artificial intelligence to perform the machine learning of “mandarin orange”, will be illustratively described.

As described above, the acquisition processing (acquisition step) of acquiring the plurality of pieces of image data is executed by the acquisition processing unit 20. Meanwhile, the user inputs the selection condition for selecting the image data to be used for causing the artificial intelligence to perform the machine learning of “mandarin orange” in the user terminal apparatus 16.

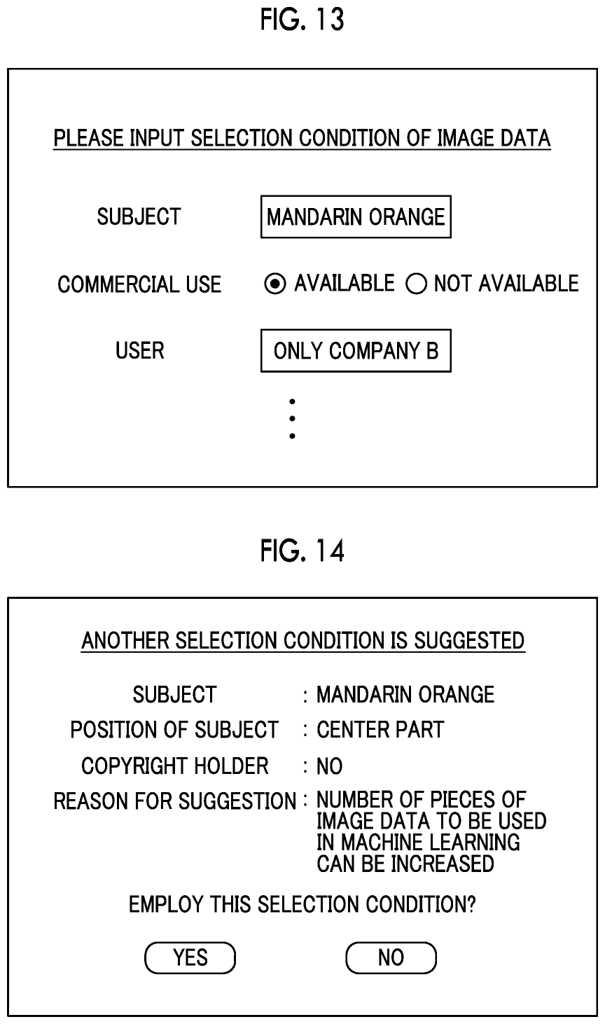

In this case, as illustrated in FIG. 13, an input screen for causing the user to input the selection condition is displayed on the display of the user terminal apparatus 16. In the example illustrated in FIG. 13, a message of “please input the selection condition of the image data” is displayed in an upper part of the input screen of the selection condition. Input fields for inputting the type of the subject, availability of commercial use, information about the user, and the like are displayed in order on a lower side of the message.

For example, as illustrated in FIG. 13, the user inputs the selection condition for selecting the image data that has “mandarin orange” as the type of the subject and that is available for commercial use and usable by only Company B on the input screen of the selection condition.

In response to this, the setting processing (setting step) of setting the first condition is executed by the setting processing unit 24, and the selection processing (selection step) of selecting the first selection image data in which the accessory information conforming to the first condition is recorded from the plurality of pieces of image data is executed by the selection processing unit 26.

Next, the suggestion processing (suggestion step) of suggesting the second condition is executed by the suggestion processing unit 28, and the notification processing (notification step) of providing notification of the information related to the second condition is executed by the notification processing unit 30.

In this case, as illustrated in FIG. 14, a suggestion screen for suggesting the second condition different from the first condition is displayed on the display of the user terminal apparatus 16. In the example illustrated in FIG. 14, input fields or the like of the selection condition suggested as the second condition, the reason for suggestion of the second condition, and whether or not to employ the second condition are displayed in order on the suggestion screen of the second condition.

In the example illustrated in FIG. 14, the selection condition for selecting the image data that has “mandarin orange” as the type of the subject and that has “mandarin orange” which is the subject in a center part of the image and “no copyright holder” is displayed as the second condition in the same manner. In addition, a message of “the number of pieces of the image data to be used in the machine learning can be increased” is displayed as the reason for suggestion of the second condition. Furthermore, a message of “employ this selection condition?” is displayed in the input field of whether or not to employ the second condition, and buttons of “yes” and “no” are displayed on a lower side of the message.

As an example different from the example illustrated in FIG. 14, the suggestion processing unit 28, for example, may suggest the selection condition for selecting the image data that has “persimmon” as the type of the subject and that has “persimmon” which is the subject in other than the center part of the image and “no copyright holder” as the second condition. In this case, for example, a message of “similar objects can be correctly distinguished” is displayed as the reason for suggestion of the second condition.

In the input field of whether or not to employ the second condition, the user presses the button of “yes” in the case of employing the suggestion and presses the button of “no” in the case of not employing the suggestion.

Consequently, in a case where the user has not employed the second condition by pressing the button of “no”, the training data is created by the creation processing unit 34 based on the first selection image data.

Meanwhile, in a case where the user has employed the second condition by pressing the button of “yes”, the second selection image data in which the accessory information conforming to the second condition is recorded is selected from the non-selection image data by the second selection processing unit 32, and the training data is created by the creation processing unit 34 based on the first selection image data and on the second selection image data.

In this example, the first selection image data and the second selection image data in which the tag information of “mandarin orange” is recorded as the accessory information are used for creating the training data to be used as the correct answer data for causing the artificial intelligence to perform the machine learning of “mandarin orange”. Meanwhile, the second selection image data in which the tag information of “persimmon” is recorded as the accessory information is used for creating the training data to be used as the incorrect answer data for causing the artificial intelligence to perform the machine learning of the fact that “persimmon” is not “mandarin orange”.

Subsequent operations are the same as described above.

Accordingly, according to the data creation apparatus 12, various and diverse pieces of image data intended by the user can be selected from an enormous amount of image data in accordance with the aim and the purpose of the machine learning. Since appropriate training data can be automatically created in a short time period based on the various and diverse pieces of image data selected from the enormous amount of the image data, a cost for creating the training data can be significantly reduced, and the accuracy of the estimation result of the artificial intelligence can be significantly improved.

The suggestion processing unit 28 may cause the artificial intelligence for performing the suggestion processing to execute the machine learning based on whether or not the user has employed the second condition, that is, an employment result of the second condition, and suggest the second condition based on the machine learning of the employment result of the second condition. In this case, the first condition that is the estimation target is input into the artificial intelligence, and the second condition is estimated from the first condition by the artificial intelligence using the trained estimation model.

In suggesting the second condition, the second condition employed by the user in the past is considered to have a higher probability of being employed by the user than the second condition not employed by the user in the past. Accordingly, the suggestion processing unit 28 preferentially suggests the second condition employed by the user in the past over the second condition not employed by the user in the past. In addition, the suggestion processing unit 28 may preferentially suggest the second condition of which the number of times of employment by the user in the past is large over the second condition of which the number of times of employment by the user in the past is small. Furthermore, the second condition that was not employed by the user in the past may not be suggested.

By repeating suggestion of the second condition of which the number of times of employment is large based on the machine learning of the employment result of the second condition, for example, based on the number of times the second condition was employed by the user in the past, the probability of the user employing the second condition can be gradually increased.

The user in this case may be the same user or a different user. In addition, the user may be one user or a plurality of users.

The suggestion processing unit 28, for example, can store histories of information related to whether or not the user has employed the second condition and information related to the number of times the user has employed the second condition in association with the first condition corresponding to the second condition, and acquire the histories of the information related to whether or not the user has employed the second condition and the information related to the number of times the user has employed the second condition that are stored in association with the first condition.

In addition, the suggestion processing unit 28 may cause the artificial intelligence for performing the suggestion processing to execute the machine learning based on the accuracy of the estimation result of the artificial intelligence and suggest the second condition based on the machine learning of the estimation result.

In causing the artificial intelligence to perform the machine learning, in a case where the accuracy of the estimation result of first artificial intelligence in a case where a first user employed the second condition in the past is higher than the accuracy of the estimation result of second artificial intelligence in a case where a second user did not employ the same second condition in the past, it is considered that the accuracy of the estimation result of the artificial intelligence can be increased in the case where the second condition is employed, compared to the case where the second is not employed.

Accordingly, in a case where the accuracy of the estimation result of the first artificial intelligence in a case where the first user has employed the second condition is higher than the accuracy of the estimation result of the second artificial intelligence in a case where the second user has not employed the second condition, the suggestion processing unit 28 suggests the second condition for the first artificial intelligence employed by the first user in the past. In other words, the suggestion processing unit 28 preferentially suggests the second condition of which employment by the user in the past has increased the accuracy of the estimation result of the artificial intelligence over the second condition of which employment by the user in the past has decreased the accuracy of the estimation result of the artificial intelligence. Furthermore, the second condition of which employment by the user in the past has decreased the accuracy of the estimation result of the artificial intelligence may not be suggested.

By repeating suggestion of the second condition of which employment by the user in the past has increased the accuracy of the estimation result of the artificial intelligence based on a history of the accuracy of the estimation result of the artificial intelligence, the accuracy of the estimation result of the artificial intelligence can be gradually increased.

The first user and the second user in this case may be the same user or different users. In addition, the first user and the second user may be one user or a plurality of users.

The suggestion processing unit 28, for example, may store the history of the accuracy of the estimation result of the artificial intelligence in association with the second condition for the artificial intelligence and acquire the history of the accuracy of the estimation result of the artificial intelligence associated with the second condition.

In the apparatus according to the embodiment of the present invention, a hardware configuration of a processing unit that executes various types of processing of the acquisition processing unit 20, the setting processing unit 24, the selection processing unit 26, the suggestion processing unit 28, the notification processing unit 30, the second selection processing unit 32, the creation processing unit 34, and the like may be dedicated hardware or may be various processors or computers executing a program.

Examples of the various processors include a central processing unit (CPU) that is a general-purpose processor functioning as various processing units by executing software (program), a programmable logic device (PLD) such as a field programmable gate array (FPGA) that is a processor having a circuit configuration changeable after manufacture, and a dedicated electric circuit such as an application specific integrated circuit (ASIC) that is a processor having a circuit configuration dedicatedly designed to execute specific processing.

One processing unit may be composed of one of the various processors or may be composed of a combination of two or more processors of the same type or different types, for example, a combination of a plurality of FPGAs or a combination of an FPGA and a CPU. In addition, a plurality of processing units may be composed of one of the various processors, or two or more of the plurality of processing units may be collectively configured using one processor.

For example, as represented by a computer such as a server and a client, a form in which one processor is composed of a combination of one or more CPUs and software and the processor functions as the plurality of processing units is possible. In addition, as represented by a system on chip (SoC) and the like, a form of using a processor that implements functions of the entire system including the plurality of processing units in one integrated circuit (IC) chip is possible.

Furthermore, a hardware configuration of the various processors is more specifically an electric circuit (circuitry) in which circuit elements such as semiconductor elements are combined.

In addition, for example, the method according to the embodiment of the present invention can be executed by a program causing a computer to execute each step of the method. In addition, a computer readable recording medium on which the program is recorded can also be provided.

### EXPLANATION OF REFERENCES

10: data processing system
12: data creation apparatus
14: machine learning apparatus
16: user terminal apparatus
18: network
20: acquisition processing unit
22: image memory
24: setting processing unit
26: selection processing unit
28: suggestion processing unit
30: notification processing unit
32: second selection processing unit
34: creation processing unit

What is claimed is:

1. A data creation apparatus that creates training data for performing machine learning from a plurality of pieces of image data in which accessory information is recorded, the data creation apparatus comprising:
a processor,
wherein the processor is configured to execute:
setting processing of setting a first condition for selecting first selection image data based on the accessory information from the plurality of pieces of image data;
selection processing of selecting the first selection image data in which the accessory information conforming to the first condition is recorded from the plurality of pieces of image data;
suggestion processing of suggesting a second condition for selecting second selection image data based on the accessory information from non-selection image data that does not conform to the first condition among the plurality of pieces of image data; and
creation processing of creating the training data based on the first selection image data in a case where a user has not employed the second condition and creating the training data based on the first selection image data and on the second selection image data in a case where the user has employed the second condition.

2. The data creation apparatus according to claim 1,
wherein the processor is configured to, in a case where the user has employed the second condition, execute second selection processing of selecting the second selection image data in which the accessory information conforming to the second condition is recorded from the non-selection image data.

3. The data creation apparatus according to claim 1,
wherein the processor is configured to execute the machine learning based on an employment result of whether or not the user has employed the second condition, and
in the suggestion processing, the second condition is suggested based on the machine learning of the employment result.

4. The data creation apparatus according to claim 1,
wherein the processor is configured to execute notification processing of providing notification of information related to the second condition.

5. The data creation apparatus according to claim 1,
wherein the first condition and the second condition include an item related to the accessory information and content related to the item.

6. The data creation apparatus according to claim 5,
wherein the first condition and the second condition have the same item and different content.

7. The data creation apparatus according to claim 6,
wherein the item is availability information related to use of image data as the training data.

8. The data creation apparatus according to claim 7,
wherein the availability information includes at least one of user information related to use of the image data, restriction information related to restriction of an aim of use of the image data, or copyright holder information of the image data.

9. The data creation apparatus according to claim 7,
wherein the content of the first condition is content of selecting image data based on the availability information, and
the content of the second condition is content of selecting image data in which the availability information is not recorded or image data in which the availability information indicating that there is no restriction on use of the image data is recorded.

10. The data creation apparatus according to claim 6,
wherein the item is an item related to a type of a subject captured in an image based on image data.

11. The data creation apparatus according to claim 1,
wherein the first condition is a condition related to a subject captured in an image based on image data, and
the suggestion processing is processing of suggesting the second condition based on a feature of the subject of the first condition.

12. The data creation apparatus according to claim 1,
wherein the suggestion processing is processing of suggesting the second condition of a higher-level concept obtained by making the first condition more abstract.

13. A data creation method of creating training data for performing machine learning from a plurality of pieces of image data in which accessory information is recorded, the data creation method comprising:
a setting step of setting a first condition for selecting first selection image data based on the accessory information from the plurality of pieces of image data;
a selection step of selecting the first selection image data in which the accessory information conforming to the first condition is recorded from the plurality of pieces of image data;
a suggestion step of suggesting a second condition for selecting second selection image data based on the accessory information from non-selection image data that does not conform to the first condition among the plurality of pieces of image data; and
a creation step of creating the training data based on the first selection image data in a case where a user has not employed the second condition and creating the training data based on the first selection image data and on the second selection image data in a case where the user has employed the second condition.

14. A program causing a computer to execute each processing of the data creation apparatus according to claim 1.

15. A computer readable recording medium on which a program causing a computer to execute each processing of the data creation apparatus according to claim 1 is recorded.

16. The data creation apparatus according to claim 2,
wherein the processor is configured to execute the machine learning based on an employment result of whether or not the user has employed the second condition, and
in the suggestion processing, the second condition is suggested based on the machine learning of the employment result.

17. The data creation apparatus according to claim 2,
wherein the processor is configured to execute notification processing of providing notification of information related to the second condition.

18. The data creation apparatus according to claim 2,
wherein the first condition and the second condition include an item related to the accessory information and content related to the item.

19. The data creation apparatus according to claim 2,
wherein the first condition is a condition related to a subject captured in an image based on image data, and
the suggestion processing is processing of suggesting the second condition based on a feature of the subject of the first condition.

20. The data creation apparatus according to claim 2,
wherein the suggestion processing is processing of suggesting the second condition of a higher-level concept obtained by making the first condition more abstract.
